(19) United States
(12) Patent Application Publication
(10) Pub. No.: US 2026/0033554 A1
(43) Pub. Date: Feb. 5, 2026

(54) AEROSOL PROVISION DEVICE TRACKING

(71) Applicant: NICOVENTURES TRADING LIMITED, London (GB)

(72) Inventors: Darryl BAKER, London (GB); Robert KERSEY, London (GB)

(21) Appl. No.: 18/997,558

(22) PCT Filed: Jul. 18, 2023
(86) PCT No.: PCT/GB2023/051879

§ 371 Date: Jan. 22, 2025

(30) Foreign Application Priority Data
Jul. 22, 2022 (GB) 2210751.0

(51) Int. Cl. A24F 40/65; H04W 4/029

(52) U.S. Cl. CPC A24F 40/65; H04W 4/029

(57) ABSTRACT

A method of tracking the location of an aerosol provision device by a user device involves, when the user device and the aerosol provision device are in remote communication: receiving, by the user device from the aerosol provision device, a location of the aerosol provision device, and storing, by the user device, the location of the aerosol provision device. In response to a request for the location of the aerosol provision device at the user device, the method involves providing, by the user device, an indication of the last-known location of the aerosol provision device based on the stored location.

### FIELD AND BACKGROUND

The present disclosure relates to the field of aerosol provision devices. In particular, but not exclusively, the present disclosure relates to tracking the location of an aerosol provision device.

Known approaches are described in WO2019121778A1, US2016331025A1, WO201816578A1, US2014174459A1, and US2018289074A1.

### SUMMARY

Viewed from a first aspect, there is provided a method of tracking the location of an aerosol provision device by a user device, the method comprising: when the user device and the aerosol provision device are in remote communication: receiving, by the user device from the aerosol provision device, a location of the aerosol provision device; storing, by the user device, the location of the aerosol provision device; and in response to a request for the location of the aerosol provision device at the user device, providing, by the user device, an indication of the last-known location of the aerosol provision device based on the stored location.

Viewed from a second aspect, there is provided a device for tracking the location of an aerosol provision device, the device configured to: when the device and the aerosol provision device are in remote communication: receive, by the device from the aerosol provision device, a location of the aerosol provision device; store, by the device, the location of the aerosol provision device; and in response to a request for the location of the aerosol provision device at the device, provide an indication of the last-known location of the aerosol provision device based on the stored location.

Viewed from a third aspect, there is provided a computer-readable medium comprising instructions which, when executed by processing circuitry of a device, cause the device to become configured to: when the device and the aerosol provision device are in remote communication: receive, by the device from the aerosol provision device, a location of the aerosol provision device; store, by the device, the location of the aerosol provision device; and in response to a request for the location of the aerosol provision device at the device, provide an indication of the last-known location of the aerosol provision device based on the stored location.

Viewed from a fourth aspect, there is provided a method of tracking the location of an aerosol provision device comprising: determining, by the aerosol provision device, a location of the aerosol provision device; and communicating, by the aerosol provision device when the aerosol provision device is in remote communication with a user device, the location of the aerosol provision device to the user device.

Viewed from a fifth aspect, there is provided an aerosol provision device comprising: a location determining element configured to determine a location of the aerosol provision device; and a communication element configured to communicate, when the aerosol provision device is in remote communication with a user device, the location of the aerosol provision device to the user device.

Viewed from a sixth aspect, there is provided a computer-readable medium comprising instructions which, when executed by processing circuitry of a device, cause the device to become configured to: determine a location of the aerosol provision device; and communicate, when the aerosol provision device is in remote communication with a user device, the location of the aerosol provision device to the user device.

Viewed from a seventh aspect, there is provided a method of tracking the location of an aerosol provision device, the method comprising: determining, by the aerosol provision device, a location of the aerosol provision device; and communicating, by the aerosol provision device when the aerosol provision device is in remote communication with a user device, the location of the aerosol provision device to the user device; receiving, by the user device from the aerosol provision device, a location of the aerosol provision device; and sending the location of the aerosol provision device to a location storage service; storing, by the location storage service, the location of the aerosol provision device; in response to a request for the location of the aerosol provision device at the user device, requesting, by the user device, the last-known location of the aerosol provision device from the location storage service; in response to the request from the user device, retrieving by the location storage service, the last-known location of the aerosol provision device and sending the last-known location of the aerosol provision device to the user device; and providing, by the user device, an indication of the last-known location of the aerosol provision device based on the received location.

Viewed from an eighth aspect, there is provide a system for tracking the location of an aerosol provision device, the system comprising: an aerosol provision device comprising: a location determining element configured to determine a location of the aerosol provision device, and a communication element configured to communicate, when the aerosol provision device is in remote communication with a device, the location of the aerosol provision device to the device; and a device configured, when the device and the aerosol provision device are in remote communication, to: receive, from the aerosol provision device, the location of the aerosol provision device, and send the location of the aerosol provision device to a location storage service; the location storage service, wherein the location storage service is configured to: store the location of the aerosol provision device; and wherein in response to a request for the location of the aerosol provision device, the device is configured to request the last-known location of the aerosol provision device from the location storage service; wherein the location storage service is configured to retrieve, in response to the request from the device, the last-known location of the aerosol provision device and send the last-known location of the aerosol provision device to the device; and wherein, the device is configured to provide an indication of the last-known location of the aerosol provision device based on the received location.

### BRIEF DESCRIPTION OF FIGURES

Embodiments and examples of the present approaches will now be described, by way of example only, with reference to the accompanying drawings, in which:

FIG. 1 is a schematic illustrating an example of an aerosol provision device with a consumable;

FIG. 2 is a schematic illustrating an example of a user device;

FIG. 3 is a schematic illustrating the non-combustible aerosol provision device, the

user device, and a location storage service;

FIG. 4 is a flowchart illustrating the operation of the aerosol provision device and the user device in tracking the location of the aerosol provision device; and

FIG. 5 is a flowchart illustrating the operation of the aerosol provision device, the user device, and the location storage service in tracking the location of the aerosol provision device.

While the presently described approach is susceptible to various modifications and alternative forms, specific embodiments are shown by way of example in the drawings and are herein described in detail. It should be understood, however, that drawings and detailed description thereto are not intended to limit the scope to the particular form disclosed, but on the contrary, the scope is to cover all modifications, equivalents and alternatives falling within the spirit and scope as defined by the appended claims.

### DETAILED DESCRIPTION

According to the present disclosure, a “non-combustible” aerosol provision system is an aerosol provision system where a constituent aerosol-generating material of the aerosol provision system (or component thereof) is not combusted or burned in order to facilitate delivery of at least one substance to a user.

The delivery system may be a non-combustible aerosol provision system, such as a powered non-combustible aerosol provision system.

The non-combustible aerosol provision system may be an electronic cigarette, also known as a vaping device or electronic nicotine delivery system (END), although it is noted that the presence of nicotine in the aerosol-generating material is not a requirement.

The non-combustible aerosol provision system may be an aerosol-generating material heating system, also known as a heat-not-burn system. An example of such a system is a tobacco heating system.

The non-combustible aerosol provision system may be a hybrid system to generate aerosol using a combination of aerosol-generating materials, one or a plurality of which may be heated. Each of the aerosol-generating materials may be, for example, in the form of a solid, liquid or gel and may or may not contain nicotine. The hybrid system may comprise a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

The non-combustible aerosol provision system, such as a non-combustible aerosol provision device thereof, may comprise a power source and a controller. The power source may, for example, be an electric power source or an exothermic power source. The exothermic power source comprises a carbon substrate which may be energised so as to distribute power in the form of heat to an aerosol-generating material or to a heat transfer material in proximity to the exothermic power source.

The non-combustible aerosol provision system may comprise an area for receiving the consumable, an aerosol generator, an aerosol generation area, a housing, a mouthpiece, a filter and/or an aerosol-modifying agent.

The consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

For convenience, non-combustible aerosol provision systems are typically quite small, often little larger than a conventional cigarette. This allows for ease of use, portability and ease of storage. However, this small size also makes it easier for a user to lose the non-combustible aerosol provision system.

The techniques described herein provide a way of tracking the location of an aerosol provision device, such as may be used with a non-combustible aerosol provision system, which can be used to aid in finding an aerosol provision device when lost for example.

In accordance with the techniques described herein, the aerosol provision device is provided with a way of determining its own location. For example, the aerosol provision device may be provided with a location determining element such as a global positioning system (GPS) element with which the aerosol provision device can determine its own position. It will be appreciated that other forms of global navigation satellite system (GNSS) may be used with an appropriate location determining element provided for the system being used.

The aerosol provision device may then communicate the determined location to a user device (e.g., a mobile phone) for the user device to store. Thus, if the user wishes to know the position of the aerosol provision device, even if the user cannot determine the location directly from the aerosol provision device and the aerosol provision device is no longer in communication with the user device, the user may consult the user device to request an indication of the last-known location.

In this way, the user can obtain an estimated position of the aerosol provision device even where the user and the user device are not in communication with the aerosol provision device. Considering as an illustrative example a situation where user leaves their aerosol provision system in a shop and only realises their aerosol provision device was missing at a later point, this approach may enable the user to identify the location at which they lost the aerosol provision device. Specifically, when in the shop, the aerosol provision device may determine its location (e.g., using a location determining element of the aerosol provision device) and communicate the location to a user device where the location was stored. If the user subsequently left the shop with the user device but leaving behind the aerosol provision device, the user could request an indication of the last-known location of the aerosol provision device from the user device. Even without the aerosol provision device being in communication with the user device at this point, the user device can provide an indication of the shop as the last-known location of the aerosol provision device.

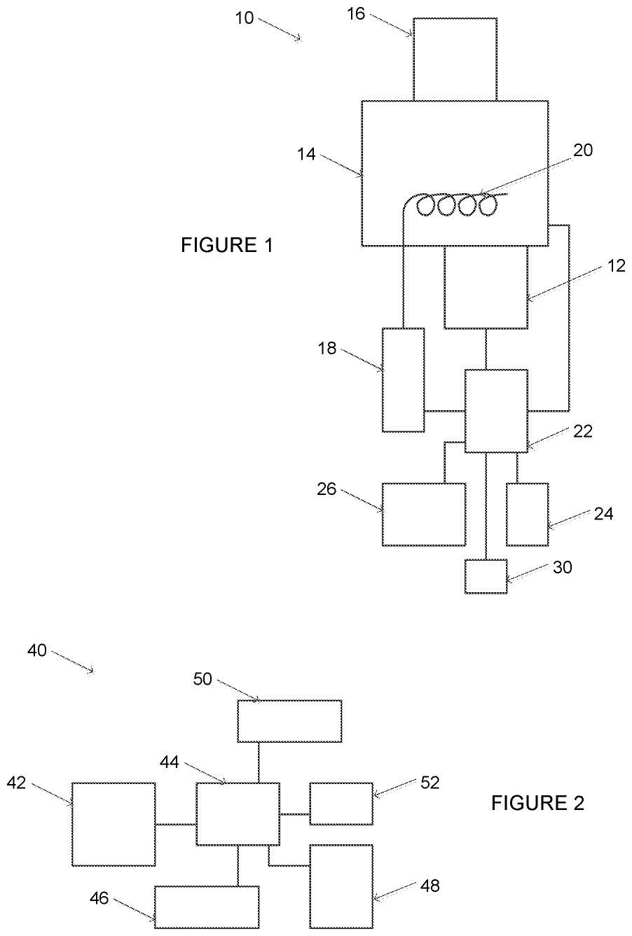

It will be appreciated that the present approaches involve transmission of data to and from an aerosol provision device, and for the aerosol provision device to process stored and/or received data. Also, the present approaches require a user device to be capable of communicating with an aerosol provision device. Such a user device may be capable of communicating with other services or systems. Therefore, to illustrate suitable devices for providing such functionalities, an example aerosol provision device 10 and an example user device 40 are illustrated with respect to FIGS. 1 and 2 respectively.

An example of an aerosol provision system is schematically illustrated in FIG. 1. As shown, the aerosol provision system includes an aerosol provision device 10 which is illustrated as, in use, including a consumable which has elements relating to aerosol generation such as an aerosol medium container or cartridge 12 (in the case of an END device, the aerosol medium container or cartridge 12 will contain nicotine or a nicotine-bearing formulation). The aerosol provision device 10 of the aerosol provision system includes, in addition to an area for receiving the consumable, an aerosol generation chamber 14 and an outlet 16 through which a generated aerosol may be discharged. A battery 18 may be provided to power a thermal generator element (such as a heater 20 which may take the form of a heater coil) within (or functionally adjacent to) the aerosol generation chamber 14. The battery 18 may also power a processor/controller 22 which may serve purposes of device usage, such as activation of the device for aerosol generation in response to an activation trigger, and purposes of communication and functionality control. Processor/controller 22 may have access to a memory 24 which may be used to store operating instructions for the processor/controller 22. The memory 24 may also be used to store data describing operating conditions and/or states of the aerosol provision device and/or one or more components thereof. The memory 24 may be internal to the processor/controller 22 or may be provided as an additional separate physical element.

To perform transmission and reception of data and/or messaging, the processor/controller 22 is provided with a communication element such as a transmitter/receiver element 26. The transmitter/receiver element 26 enables the aerosol provision device 10 to communicate with a connected device using a connectivity technology such as a personal area network protocol. Example personal area network protocols include Bluetooth™, Bluetooth Low Energy™ (BLE), Zigbee™, Wireless USB, and Near-field communication (NFC). Example personal area network protocols also include protocols making use of optical communication such as Infrared Data association (IrDA), and data-over-sound. Other wireless technologies such as a Wi-Fi™ technology may be used if the aerosol provision device has suitable capability. In other examples, the transmitter/receiver element 26 may be configured to provide for a wired communication channel provided between physical ports of the aerosol provision device 10 and a connected device. Such a wired communication channel may utilise a physical connection technology such as USB™, a serial port, FireWire™ or other point-to-point wired connectivity. The remainder of this discussion will use the example of BLE and will use BLE terminology, although it will be appreciated that corresponding or equivalent functionalities of other personal area network technologies may be substituted. Thus, in the present example, the transmitter/receiver element 26 is a BLE interface element including or connected to a radio antenna for wireless communication. In other examples such as those indicated above this may be an interface element for an alternative wireless technology and/or a wired connection interface.

Any communication established with a connected device may be impermanent or otherwise transient in the sense that the channel may be established for a period of time necessary to carry out specific functionalities, but may also be disconnected when not required. For this reason such a connected device will be referred to herein as a user device, in the sense that the device is likely to be utilised and/or controlled by a user of the aerosol provision device and a connected device. An example of such a user device (which may also be termed a remote device, in the sense that the device is remote from the aerosol provision device, or intermediary device, in the sense that the device is intermediate between the aerosol provision device and the unlock/age verification services) is described below with reference to FIG. 2.

Returning to the discussion of FIG. 1, the aerosol provision device 10 is provided with a location determining element 30 to determine the location of the aerosol provision device 10.

The location determining element 30 may operate according to any of a range of possible protocols for determining the location of the aerosol provision device 10. In some examples, the location determining element 30 is a global navigation satellite system (GNSS) element configured to determine the location using GNSS. For example, the GNSS element may be any of a Global Positioning System (GPS) element, a Global Navigation System (GLONASS) element, a Galileo element, or a BeiDou Navigation Satellite System element (BDS), each configured to determine the location of the aerosol provision device using the corresponding protocol.

In some examples, the location determining element 30 is a Wi-Fi™ element to determine the location of the aerosol provision device using Wi-Fi™ positioning based on the characteristics of nearby wireless access points. Alternatively, or additionally, the location determining element 30 may be a cell phone tower locating element to determine the location using cell phone tower triangulation. Further, the location determining element 30 may be a Low Power Wide Area Network (LPWAN) element or a low power internet of things (IOT) network element to determine the location using communication over LPWAN or IoT network respectively. The location determining element may be a Near-field communication (NFC) element to determine the location based on recognising a Near-field communication tag having a known location.

In some examples, the location determining element 30 comprises two or more location determining sub-elements operating according to different protocols (such as the protocols set out above) in order to provide additional resilience and/or accuracy where the location determination from one or some of the location determining sub-elements is unavailable or inaccurate.

The processor/controller 22 may in one example be an STM32 microcontroller as provided by ST Microelectronics and based on the ARM™ Cortex™-M processor. In other examples an alternative microcontroller or processor may be used, which may be based upon an ARM™ architecture, an Atom™ architecture or other low power processor technology. Alternatively or additionally, the transmitter/receiver element 26 may in one example include an nRF BLE chip for cooperating with the processor/controller to provide BLE connectivity to the aerosol provision device. In other examples, other communication interface chips or modules may be deployed to provide connectivity services.

As illustrated, processor/controller 22 may be connected for example to aerosol medium container or cartridge 12, aerosol generation chamber 14 and battery 18. This connection may be to an interface connection or output from ones of the components and/or may be to a sensor located at or in ones of the components. These connections may provide access by the processor to properties of the respective components. For example a battery connection may be used to control activation of the aerosol provision device for aerosol generation.

Further functionalities of the processor/controller 22 and/or the memory 24 will be described with reference to the examples of the present approaches below.

An example of a user device 40 is schematically illustrated in FIG. 2. The user device may be a device such as a mobile telephone (cellphone) or tablet of a user (and/or owner) of the aerosol provision device 10. As shown, the user device 40 includes a receiver transmitter element 42 for communicating with an aerosol provision device 10. Thus the receiver transmitter element 42 will be configured to use the same connectivity and protocols etc as the aerosol provision device 10 with which it is to interact in any given implementation. Accordingly, in the present examples, the receiver transmitter element 42 is a BLE interface element including or connected to a radio antenna for wireless communication. In other examples such as those indicated above this may be an interface element for an alternative wireless technology and/or a wired connection interface.

The receiver transmitter element 42 is connected to a processor or controller 44 which can receive and process the data or messaging received from the aerosol provision device. The processor or controller 44 has access to a memory 46 which can be used to store program information and/or data. The user device 40 may include a further data transmission interface 48. This interface may provide one or more interface functionalities, for example to a wired connection such as wired local area network and/or to a wireless connection such as wireless local area network and/or cellular data services. This interface may be used for example for sending and receipt of messaging to and from various other devices, computer systems, and/or computer services as required by any particular implementation. This interface may also or alternatively be used for communications relating to other functionalities of the user device 40 which are unrelated to operation of or interaction with an aerosol provision device.

The user device 40 also includes user interface elements including an output device 50 (which may include one or more of a display, an audio output, and a haptic output) and an input device 52 (which may include one or more of buttons, keys, touch-sensitive display elements, or a mouse/trackpad).

The user device 40 may be pre-programmed or configured to provide the functionalities according to the approaches discussed below. Additionally or alternatively, the user device may store software (e.g. in memory 46) such as an app to cause the processor or controller 44 to have those functionalities when the software is executed. Thus the user device may be a multi-purpose device that has the described functionalities when the app is executed.

Software to cause the user device to become programmed for the techniques described herein may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media such as carrier signals and transmission media. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media.

The term “computer-readable storage media” refers to physical storage media. Transient communication media may occur between components of a single computing system (e.g. on an internal link or bus between e.g. a memory and processor) or between separate computing systems (e.g. over a network or other inter-computing device connection), and may include transmission signals, carrier waves or the like.

Such software may be loaded directly to the user device 40 from a computer-readable medium, or may be loaded to the user device by connecting the user device to another computing device (such as a desktop computer, laptop computer or the like) and using software on the other computing device to control the loading of software to the user device.

Thus there have been described an aerosol provision device and a user device that may interact to provide a number of additional functionalities for the aerosol provision device to a user of the user device. Examples of such functionalities will now be described.

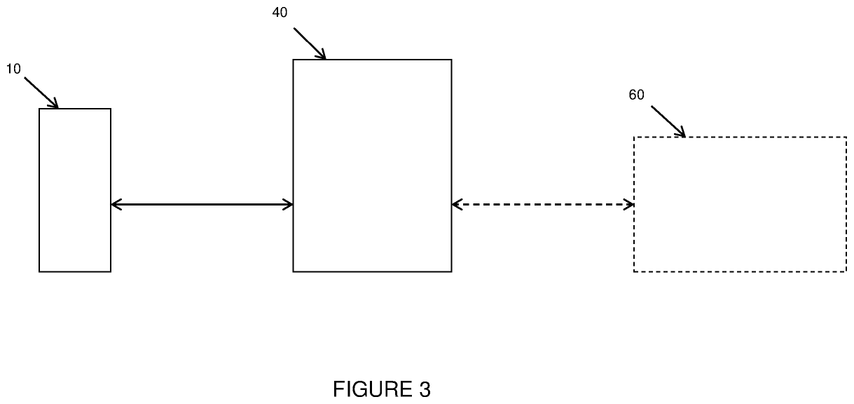

FIG. 3 is a schematic illustrating the aerosol provision device 10, the user device 40 and a location storage service 60. As shown in FIG. 3, the aerosol provision device 10 is in communication with the user device 40. This communication may occur using any suitable communication technology and/or protocol such as those discussed above with reference to FIGS. 1 and 2. For example, the aerosol provision device 10 may be in communication with the user device 40 via a BLE connection. However, the user device 40 and aerosol provision device 10 may lose communication with one another. This may occur due to a range of the form of communication being employed being exceeded (which may be the case where the connection is a BLE connection) or a physical connection between the aerosol provision device 10 and the user device 40 being broken for example.

In some examples, the user device 40 is also in communication with a location storage service 60. The location storage service provides storage functionality for indications of the location of the aerosol provision device 10. Thus, the user device 40, instead of or as well as storing a location indication of the location of the aerosol provision device 10, may provide an indication of the location of the aerosol provision device 10 to the location storage service 60. This may be done to provide a back-up of the stored location in case this information was lost from the user device 40 or the user device 40 itself was lost, and/or to avoid needing to store the location on the user device 40, e.g., to reduce the storage requirements of the user device 40. Where the location storage service 60 is located remotely from the user device 40, the user device 40 may be in communication with the location storage service 60 via the Internet.

The location storage service 60 may be implemented using remote hardware (e.g., one or more servers) and may be operated for example by a vendor/manufacturer of the aerosol provision device 10, by the user, or by a third party.

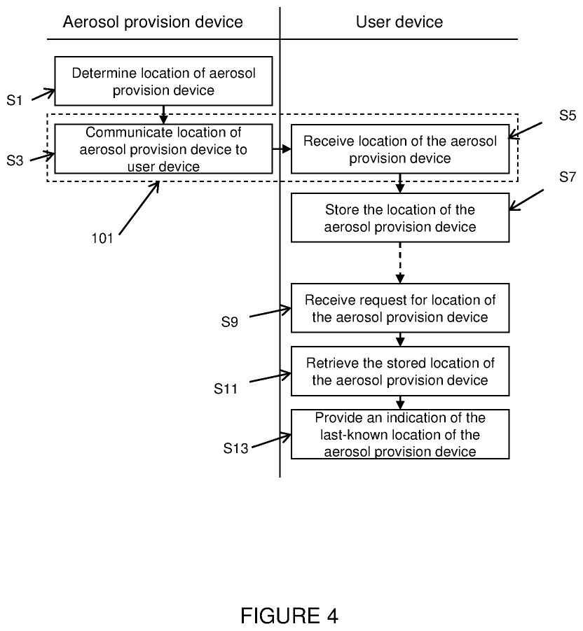

The operation of the aerosol provision device 10 and the user device 40 in tracking the location of the aerosol provision device 10 will now be described with reference to FIG. 4.

In step S1 of FIG. 4, the aerosol provision device 10 determines its own location. This is done using the location determining element 30 of the aerosol provision device 10 and may be done using the techniques described with reference to FIG. 1.

The aerosol provision device 10 then communicates the location to the user device 40 at step S3, which location is received by the user device at step S5. At least during the period for which the location of the aerosol provision device 10 is communicating the location to the user device 40, the aerosol provision device 10 and user device 40 are able to communicate (e.g., are within BLE range) with each other. This communication can occur using BLE for example or may occur using an alternative mode of communication, such as those described above with reference to FIGS. 1 and 2.

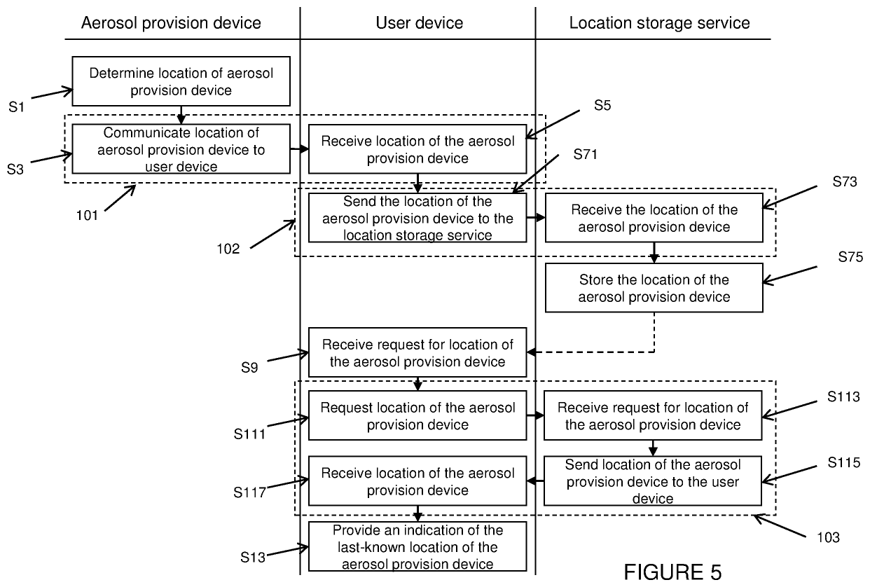

Upon receiving the location of the aerosol provision device 10, the user device 40 stores the location of the aerosol provision device 10 at step S7. The user device 40 may store the location locally (i.e., on the user device 40 itself) or may be arranged to store the location elsewhere. Such an approach where the location is stored at a location storage service 60 is discussed below with reference to FIG. 5. By storing the location in this way, the user device 40 is be able to provide an indication of the location of the aerosol provision device 10 even if the user device 40 subsequently loses contact with the aerosol provision device 10 and hence cannot receive a location from the aerosol provision device 10.

As illustrated with the dashed box 101 in FIG. 4, at least while the steps S3-S5 are carried out, the aerosol provision device 10 and the user device 40 are in communication (e.g., the devices are within BLE range of each other). It will be appreciated that the method shown in FIG. 4 may be carried out in situations where the duration of aerosol provision device 10 and user device 40 being in communication lasts for longer than the time required to carry out steps S3 and S5. For example, while the aerosol provision device 10 and user device 40 may lose contact with each other in the period between the user device 40 receiving the location from the aerosol provision device 10 (at step S5) and storing the location (at step S7), it is entirely possible for any of steps S7 through to S13 to be performed while the aerosol provision device 10 and user device 40 are still in communication. Thus the user device 40 may nonetheless store the location (S7) and proceed with the remaining steps of the method even when the aerosol provision device 10 and user device 40 remain in communication.

Further, the aerosol provision device may perform step S1 even when the aerosol provision device 10 is not in communication with the user device 40, so that the aerosol provision device 10 may have a determined location which it can forward to the user device 40 when the aerosol provision device 10 and user device 40 come into communication. In some implementations, the aerosol provision device 10 may be configured to refrain from performing step S1 while the aerosol provision device 10 and user device 40 are not in communication, for example to avoid expending power on step S1 at a time when step S3 cannot be performed due to there being no user device 40 presently in communication with the aerosol provision device 10.

In some examples, steps S1-S7 are performed repeatedly in order to update the stored last-known location. By performing these steps repeatedly, the user device 40 is more likely to have access to an up-to-date indication of the location of the aerosol provision device 10. In some examples, steps S1-S7 involving determining the location of the aerosol provision device 10, transmitting the location to the user device 40 and storing the location are performed regularly (e.g., at predetermined intervals) and/or may be performed whenever it is detected that the aerosol provision device 10 has changed location (for example where the location has changes by more than a threshold amount of distance).

Where steps S1-S7 are performed more than once, the user device 40 may be arranged, on receipt of an updated location for the aerosol provision device 10 to replace the previous stored indication of a location to avoid increasing the storage space occupied by the stored locations. In some examples, however, the user device 40 may maintain the previous stored location or locations so that a history of the movement of the aerosol provision device 10 can be established. In such examples, the user device 40 may be arranged to provide an indication of the movement of the aerosol provision device 10 on the basis of this stored location history information.

At step S9, the user device 40 receives a request for the location of the aerosol provision device 10. This request may be received for example from a user and by an app running on the user device 40. However, in some examples, the user device 40 may be receptive to requests for the location of the aerosol provision device 10 received from elsewhere such as from a separate device.

In response to the request for the location of the aerosol provision device 10, the user device 40 retrieves the stored location of the aerosol provision device 10 (or the most recent location if multiple locations have been stored) at step S11. Where the location has been stored locally at the user device 40 (e.g., in system storage of the user device 40), retrieving the stored location involves retrieving the location from the storage. It will be appreciated that where the location of the aerosol provision device 10 has been stored elsewhere, the retrieval may take a corresponding form.

With the stored location retrieved, the user device 40 provides an indication of the last-known location of the aerosol provision device 10 based on the stored indication at step S13. The indication may take the form of a message displayed at the user device 40 stating the location. Additionally or alternatively, the user device 40 may indicate the location by displaying the location of the aerosol provision device 10 on a map and/or by displaying a location of the aerosol provision device relative to the user device 40 (e.g., by displaying an arrow indicating a direction to the aerosol provision device 10 and a distance of separation).

Thus there has been described an approach by which a user is able to receive an indication of the last-known location of the aerosol provision device 10 based on position measurements made by the aerosol provision device 10 and received by the user device 40 while the user device 40 was still in communication with the aerosol provision device 10, even if the aerosol provision device 10 and the user device are no longer in communication.

FIG. 5 is a flowchart illustrating the operation of the non-combustible aerosol provision device 10, the user device 40, and the location storage service 60 in tracking the location of the non-combustible aerosol provision device 10.

The method depicted in FIG. 5 has many steps in common with the method discussed with reference to FIG. 4. Corresponding steps are illustrated with the same reference sign and will not be discussed in detail again.

The approach detailed in FIG. 5 makes use of the location storage service 60 to store the location information received from the aerosol provision device 10. This location storage service 60 may be located remotely from the user device 40 and may provide secure storage of the location information, thereby protecting against the loss of such information by the user device 40 and reducing the storage requirements on the user device 40 for storing the location information. This approach may also protect against loss of the user device 40, as a user whose user device 40 has become (permanently or temporarily) lost or unusable may be able to access the location stored at the location storage service from an alternative user device.

Unlike the method depicted in FIG. 4 however, following receipt of the location of the aerosol provision device 10 by the user device 40 at step S5, the user device 40 sends the location of the aerosol provision device to the location storage service at step S71. This location may be sent for example over the Internet, over a local network, or via other communication means. The form of communication used may be selected based on the form of the location storage service 60. For example, the location storage service 60 may be operated by or on behalf of a manufacturer/vendor of the aerosol provision device, in which case the location storage service 60 may be implemented using servers operated by that manufacturer/vendor and accessible over the Internet. In some examples however, the location storage service 60 may be implemented by a device owned by the user themself, such that when the user device 40 and the device implementing the location storage service 60 are in communication with each other (e.g., over a local network/via a wired connection), the user device 40 sends the location to the location storage service 60.

After receiving the location at step S73, the location storage service 60 stores the location at step S75.

As illustrated by the dashed box 101, at least steps S3-S5 are carried out while the aerosol provision device 10 is in communication with the user device 40. As discussed above in relation to FIG. 4, additional steps in the method may also be carried out while the aerosol provision device 10 is in communication with the user device 40.

As further illustrated by the dashed boxes 102 and 103, at least steps S71-S75 and steps S111-S115 (discussed below) are carried out while the user device 40 is in communication with the location storage service 60. In similar manner to the discussion of the connectivity discussed with respect to steps S3 and S5 in FIG. 4 above, additional steps of the method may be performed while the user device 40 is in communication with the location storage service 60.

These steps may also be repeated one or more times and may be performed regularly so that an up-to-date location of the aerosol provision device 10 is maintained at the location storage service 60.

With the location of the aerosol provision device 10 stored at the location storage service, when the user device 40 receives a request for the location of the aerosol provision device 10 at step S9, instead of retrieving the location from a local storage of the user device 40, the user device 40 requests the location of the aerosol provision device 10 from the location storage service 60 at step S111. This request is received by the location storage service 60 at step S113, whereupon the location storage service 60 provides the stored location to the user device 40 at step S115. In response to receipt of this location at step S117, the user device 40 provides an indication of the last-known location as received from the location storage service 60 at step S13.

Thus, there has been described an approach by which the location as determined by the aerosol provision device 10 can be recorded with the location storage service 60, thereby not requiring storage of the location by the user device 40 and/or providing protection against loss of (data from) the user device 40. The location information is therefore available to the user device 40 when the position of the aerosol provision device 10 is unknown to a user. Hence, if the user were to lose the aerosol provision device 10, the user device 40 and the location storage service 60 can be used to determine a last-known location of that aerosol provision device 10 which may aid in finding the aerosol provision device 10.

In some examples, the functionality illustrated with respect to FIGS. 4 and 5 may be combined as a hybrid arrangement, such as to provide storage of a location received by the user device 40 in addition to providing storage of that location at a location storage service 60. Such a hybrid approach allows, for example for a location received at step S5 to be stored at the user device 40 while the user device awaits connectivity to the location service 60. The user device 40 may then continue to store the location received at step S5 after sending the location to the location storage service at step S71, or may cease storing the location once step S71 has been performed. Such a hybrid approach also allows for the overall implementation to be robust both to connectivity failure between the user device 40 and location storage service 60, and to loss of location information by the user device 40 and/or loss (whether permanent or temporary) of the user device 40. In such a hybrid approach, a location request may be serviced using a locally-stored location from the user device 40 when available, and using a location retrieved from the location storage service 60 when the user device 40 does not have a stored location available. In some examples, the user device 40 may compare a stored location available at the user device 40 and from the location storage service 60 and provide a most recent one of these two stored locations.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

### CONSISTORY SET OF CLAUSES

1. A method of tracking the location of an aerosol provision device by a user device, the method comprising:
when the user device and the aerosol provision device are in remote communication:
receiving, by the user device from the aerosol provision device, a location of the aerosol provision device;
storing, by the user device, the location of the aerosol provision device; and
in response to a request for the location of the aerosol provision device at the user device, providing, by the user device, an indication of the last-known location of the aerosol provision device based on the stored location.

2. The method according to clause 1, wherein:
the location of the aerosol provision device received by the user device is a location determined using a global navigation satellite system (GNSS).

3. The method according to clause 2, wherein:
the GNSS is selected from the group comprising: Global Positioning System (GPS); Global Navigation Satellite System (GLONASS); Galileo; and BeiDou Navigation Satellite System (BDS).

4. The method according to clause 1, 2 or 3, wherein:
the location of the aerosol provision device received by the user device is a location determined using Wi-Fi™ positioning, wherein the location of the aerosol provision device is determined based on the characteristics of nearby wireless access points.

5. The method according to any preceding clause, wherein:
the location of the aerosol provision device received by the user device is a location determined using cell phone tower triangulation.

6. The method according to any preceding clause, wherein:
the location of the aerosol provision device received by the user device is a location determined using communication over a Low Power Wide Area Network (LPWAN).

7. The method according to any preceding clause, wherein:
the location of the aerosol provision device received by the user device is a location determined using communication over a low power internet of things (IOT) network.

8. The method according to any preceding clause, wherein:
the location of the aerosol provision device received by the user device is a location determined based on recognising a Near-field communication tag having a known location.

9. The method according to any preceding clause, wherein:
storing the location of the aerosol provision device by the user device comprises sending the location of the aerosol provision device to a location storage service; and
providing the indication of the last-known location of the aerosol provision device by the user device comprises retrieving, from the location storage service, the last-known location of the aerosol provision device.

10. The method according to any preceding clause, wherein:
receiving the location of the aerosol provision device from the aerosol provision device is via a Bluetooth™ protocol.

11. The method according to any of clauses 1-9, wherein:
the location of the aerosol provision device is received from the aerosol provision device via a mobile network.

12. The method of any preceding clause, wherein:
providing, by the user device, an indication of the last-known location of the aerosol provision device based on the stored location is performed when the user device and the aerosol provision device are not in remote communication.

13. A device for tracking the location of an aerosol provision device, the device configured to:
when the device and the aerosol provision device are in remote communication:
   receive, by the device from the aerosol provision device, a location of the aerosol provision device;
   store, by the device, the location of the aerosol provision device; and in response to a request for the location of the aerosol provision device at the device,
provide an indication of the last-known location of the aerosol provision device based on the stored location.

14. The device according to clause 13, wherein:
the location of the aerosol provision device received by the device is a location determined using a global navigation satellite system (GNSS).

15. The device according to clause 14, wherein:
the GNSS is selected from the group comprising: Global Positioning System (GPS); Global Navigation Satellite System (GLONASS); Galileo; and BeiDou Navigation Satellite System (BDS).

16. The device according to clause 13, 14 or 15, wherein:
the location of the aerosol provision device received by the device is a location determined using Wi-Fi™ positioning, wherein the location of the aerosol provision device is determined based on the characteristics of nearby wireless access points.

17. The device according to any of clauses 13-16, wherein:
the location of the aerosol provision device received by the device is a location determined using cell phone tower triangulation.

18. The device according to any of clauses 13-17, wherein:
the location of the aerosol provision device received by the device is a location determined using communication over a Low Power Wide Area Network (LPWAN).

19. The device according to any of clauses 13-18, wherein:
the location of the aerosol provision device received by the device is a location determined using communication over a low power internet of things (IOT) network.

20. The device according to any of clauses 13-19, wherein:
the location of the aerosol provision device received by the device is a location determined based on recognising a Near-field communication tag having a known location.

21. The device according to any of clauses 13-20, wherein:
to store the location of the aerosol provision device, the device is configured to send the location of the aerosol provision device to a location storage service; and
to provide the indication of the last-known location of the aerosol provision device, the device is configured to retrieve, from the location storage service, the last-known location of the aerosol provision device.

22. The device according to any of clauses 13-21, wherein:
receiving the location of the aerosol provision device from the aerosol provision device is via a Bluetooth™ protocol.

23. The device according to any of clauses 13-21, wherein:
the device is configured to receive the location of the aerosol provision device from the aerosol provision device via a mobile network.

24. The device according to any of clauses 13-23, wherein:
the device is configured to provide the indication of the last-known location of the aerosol provision device based on the stored location when the device and the aerosol provision device are not in remote communication.

25. A computer-readable medium comprising instructions which, when executed by processing circuitry of a device, cause the device to become configured to:
when the device and the aerosol provision device are in remote communication:
   receive, by the device from the aerosol provision device, a location of the aerosol provision device;
   store, by the device, the location of the aerosol provision device; and
   in response to a request for the location of the aerosol provision device at the device, provide an indication of the last-known location of the aerosol provision device based on the stored location.

26. The computer-readable medium according to clause 25, wherein:
the location of the aerosol provision device received by the device is a location determined using a global navigation satellite system (GNSS).

27. The computer-readable medium according to clause 26, wherein:
the GNSS is selected from the group comprising: Global Positioning System (GPS); Global Navigation Satellite System (GLONASS); Galileo; and BeiDou Navigation Satellite System (BDS).

28. The computer-readable medium according to clause 25, 26 or 27, wherein:
the location of the aerosol provision device received by the device is a location determined using Wi-Fi™ positioning, wherein the location of the aerosol provision device is determined based on the characteristics of nearby wireless access points.

29. The computer-readable medium according to any of clauses 25-28, wherein:
the location of the aerosol provision device received by the device is a location determined using cell phone tower triangulation.

30. The computer-readable medium according to any of clauses 25-29, wherein:
the location of the aerosol provision device received by the device is a location determined using communication over a Low Power Wide Area Network (LPWAN).

31. The computer-readable medium according to any of clauses 25-30, wherein:
the location of the aerosol provision device received by the device is a location determined using communication over a low power internet of things (IOT) network.

32. The computer-readable medium according to any of clauses 25-31, wherein:
the location of the aerosol provision device received by the device is a location determined based on recognising a Near-field communication tag having a known location.

33. The computer-readable medium according to any of clauses 25-32, wherein:
to store the location of the aerosol provision device, instructions cause the device to send the location of the aerosol provision device to a location storage service; and
to provide the indication of the last-known location of the aerosol provision device, the instructions cause the device to retrieve, from the location storage service, the last-known location of the aerosol provision device.

34. The computer-readable medium according to any of clauses 25-33, wherein:
receiving the location of the aerosol provision device from the aerosol provision device is via a Bluetooth™ protocol.

35. The computer-readable medium according to any of clauses 25-33, wherein:
the device is configured to receive the location of the aerosol provision device from the aerosol provision device via a mobile network.

36. The computer-readable medium according to any of clauses 25-35, wherein:
the device is configured to provide the indication of the last-known location of the aerosol provision device based on the stored location when the device and the aerosol provision device are not in remote communication 37. A method of tracking the location of an aerosol provision device comprising:
determining, by the aerosol provision device, a location of the aerosol provision device; and
communicating, by the aerosol provision device when the aerosol provision device is in remote communication with a user device, the location of the aerosol provision device to the user device.

38. The method according to clause 37, wherein:
the location of the aerosol provision device is a location determined using a global navigation satellite system (GNSS).

39. The method according to clause 38, wherein:
the GNSS is selected from the group comprising: Global Positioning System (GPS); Global Navigation Satellite System (GLONASS); Galileo; and BeiDou Navigation Satellite System (BDS).

40. The method according to clause 37, 38 or 39, wherein:
the location of the non-combustible aerosol provision is a location determined using Wi-Fi™ positioning, wherein the location of the aerosol provision device is determined based on the characteristics of nearby wireless access points.

41. The method according to any of clauses 37-40, wherein:
the location of the aerosol provision device is a location determined using cell phone tower triangulation.

42. The method according to any of clauses 37-41, wherein:
the location of the aerosol provision device is a location determined using communication over a Low Power Wide Area Network (LPWAN).

43. The method according to any of clauses 37-42, wherein:
the location of the aerosol provision device is a location determined using communication over a low power internet of things (IOT) network.

44. The method according to any of clauses 37-43, wherein:
the location of the aerosol provision device is a location determined based on recognising a Near-field communication tag having a known location.

45. The method according to any of clauses 37-44, wherein:
communicating the location of the aerosol provision device to the user device is via a Bluetooth™ protocol.

46. The method according to any of clauses 37-44, wherein:
communicating the location of the aerosol provision device to the user device is via a mobile network.

47. An aerosol provision device comprising:
a location determining element configured to determine a location of the aerosol provision device; and
a communication element configured to communicate, when the aerosol provision device is in remote communication with a user device, the location of the aerosol provision device to the user device.

48. The aerosol provision device according to clause 47, wherein:
the location determining element is a global navigation satellite system (GNSS) element configured to determine the location of the aerosol provision device using a GNSS.

49. The aerosol provision device according to clause 48, wherein:
the GNSS element is selected from the group comprising: a Global Positioning System (GPS) element; a Global Navigation Satellite System (GLONASS) element; a Galileo element;
and a BeiDou Navigation Satellite System element (BDS) and the GNSS is selected from the group comprising: GPS; GLONASS; Galileo; and BDS.

50. The aerosol provision device according to clause 47, 48 or 49, wherein:
the location determining element is a Wi-Fi™ element configured to determine the location of the aerosol provision device using Wi-Fi™ positioning, wherein the location of the aerosol provision device is determined based on the characteristics of nearby wireless access points.

51. The aerosol provision device according to any of clauses 47-50, wherein:
the location determining element is a cell phone tower locating element configured to determine the location using cell phone tower triangulation.

52. The aerosol provision device according to any of clauses 47-51, wherein:
the location determining element is a Low Power Wide Area Network (LPWAN) element configured to determine the location of the aerosol provision device using communication over a Low Power Wide Area Network (LPWAN).

53. The aerosol provision device according to any of clauses 47-52, wherein:
the location determining element is a low power internet of things (IOT) network element configured to determine the location using communication over a low power internet of things (IoT) network.

54. The aerosol provision device according to any of clauses 47-53, wherein:
the location determining element is a Near-field communication (NFC) element configured to determine the location based on recognising a Near-field communication tag having a known location.

55. The aerosol provision device according to any of clauses 47-54, wherein:
the aerosol provision device is configured to communicate the location of the aerosol provision device to the user device via a Bluetooth™ protocol.

56. The aerosol provision device according to any of clauses 47-54, wherein:
the aerosol provision device is configured to communicate the location of the aerosol provision device to the user device via a mobile network.

57. A computer-readable medium comprising instructions which, when executed by processing circuitry of a device, cause the device to become configured to:
determine a location of the aerosol provision device; and
communicate, when the aerosol provision device is in remote communication with a user device, the location of the aerosol provision device to the user device.

58. The computer-readable medium according to clause 57, wherein:
the location of the aerosol provision device is a location determined using a global navigation satellite system (GNSS).

59. The computer-readable medium according to clause 58, wherein:
the GNSS is selected from the group comprising: Global Positioning System (GPS); Global Navigation Satellite System (GLONASS); Galileo; and BeiDou Navigation Satellite System (BDS).

60. The computer-readable medium according to clause 57, 58 or 59, wherein:
the location of the non-combustible aerosol provision is a location determined using Wi-Fi™ positioning, wherein the location of the aerosol provision device is determined based on the characteristics of nearby wireless access points.

61. The computer-readable medium according to any of clauses 57-60, wherein:
the location of the aerosol provision device is a location determined using cell phone tower triangulation.

62. The computer-readable medium according to any of clauses 57-61, wherein:
the location of the aerosol provision device is a location determined using communication over a Low Power Wide Area Network (LPWAN).

63. The computer-readable medium according to any of clauses 57-62, wherein:
the location of the aerosol provision device is a location determined using communication over a low power internet of things (IOT) network.

64. The computer-readable medium according to any of clauses 57-63, wherein:
the location of the aerosol provision device is a location determined based on recognising a Near-field communication tag having a known location.

65. The computer-readable medium according to any of clauses 57-64, wherein:
communicating the location of the aerosol provision device to the user device is via a Bluetooth™ protocol.

66. The computer-readable medium according to any of clauses 57-64, wherein:
communicating the location of the aerosol provision device to the user device is via a mobile network.

67. A method of tracking the location of an aerosol provision device, the method comprising:
determining, by the aerosol provision device, a location of the aerosol provision device; and
communicating, by the aerosol provision device when the aerosol provision device is in remote communication with a user device, the location of the aerosol provision device to the user device;
receiving, by the user device from the aerosol provision device, a location of the aerosol provision device;
storing, by the user device, the location of the aerosol provision device; and
in response to a request for the location of the aerosol provision device at the user device, providing, by the user device, an indication of the last-known location of the aerosol provision device based on the stored location.

68. The method according to clause 67, wherein:
the location of the aerosol provision device is a location determined using a global navigation satellite system (GNSS).

69. The method according to clause 68, wherein:
the GNSS is selected from the group comprising: Global Positioning System (GPS); Global Navigation Satellite System (GLONASS); Galileo; and BeiDou Navigation Satellite System (BDS).

70. The method according to clause 67, 68 or 69, wherein:
the location of the non-combustible aerosol provision is a location determined using Wi-Fi™ positioning, wherein the location of the aerosol provision device is determined based on the characteristics of nearby wireless access points.

71. The method according to any of clauses 67-70, wherein:
the location of the aerosol provision device is a location determined using cell phone tower triangulation.

72. The method according to any of clauses 67-71, wherein:
the location of the aerosol provision device is a location determined using communication over a Low Power Wide Area Network (LPWAN).

73. The method according to any of clauses 67-72, wherein:
the location of the aerosol provision device is a location determined using communication over a low power internet of things (IOT) network.

74. The method according to any of clauses 67-73, wherein:
the location of the aerosol provision device is a location determined based on recognising a Near-field communication tag having a known location.

75. The method according to any of clauses 67-74, wherein:
storing the location of the aerosol provision device by the user device comprises sending the location of the aerosol provision device to a location storage service; and
providing the indication of the last-known location of the aerosol provision device by the user device comprises retrieving, from the location storage service, the last-known location of the aerosol provision device.

76. The method according to any of clauses 67-75, wherein:
communicating the location of the aerosol provision device to the user device is via a Bluetooth™ protocol.

77. The method according to any of clauses 67-75, wherein:
communicating the location of the aerosol provision device to the user device is via a mobile network.

78. The method of any of clauses 67-77, wherein:
providing, by the user device, an indication of the last-known location of the aerosol provision device based on the stored location is performed when the user device and the aerosol provision device are not in remote communication.

79. A system for tracking the location of an aerosol provision device, the system comprising:
an aerosol provision device comprising:
   a location determining element configured to determine a location of the aerosol provision device, and
   a communication element configured to communicate, when the aerosol provision device is in remote communication with a device, the location of the aerosol provision device to the device; and
a device configured, when the device and the aerosol provision device are in remote communication, to:
   receive, from the aerosol provision device, the location of the aerosol provision device, and
   store the location of the aerosol provision device; and
   in response to a request for the location of the aerosol provision device, provide an indication of the last-known location of the aerosol provision device based on the received location.

80. The system according to clause 79, wherein:
the location determining element is a global navigation satellite system (GNSS) element configured to determine the location of the aerosol provision device using a GNSS.

81. The system according to clause 80, wherein:
the GNSS element is selected from the group comprising: a Global Positioning System (GPS) element; a Global Navigation Satellite System element (GLONASS); a Galileo element; and a BeiDou Navigation Satellite System element (BDS) and the GNSS is selected from the group comprising: GPS; GLONASS; Galileo; and BDS.

82. The system according to clause 79, 80 or 81, wherein:
the location determining element is a Wi-Fi™ element configured to determine the location of the aerosol provision device using Wi-Fi™ positioning, wherein the location of the aerosol provision device is determined based on the characteristics of nearby wireless access points.

83. The system according to any of clauses 79-82, wherein:
the location determining element is a cell phone tower locating element configured to determine the location using cell phone tower triangulation.

84. The system according to any of clauses 79-83, wherein:
the location determining element is a Low Power Wide Area Network (LPWAN) element configured to determine the location of the aerosol provision device using communication over a Low Power Wide Area Network (LPWAN).

85. The system according to any of clauses 79-84, wherein:
the location determining element is a low power internet of things (IOT) network element configured to determine the location using communication over a low power internet of things (IoT) network.

86. The system according to any of clauses 79-85, wherein:
the location determining element is a Near-field communication (NFC) element configured to determine the location based on recognising a Near-field communication tag having a known location.

87. The system according to any of clauses 79-86, further comprising:
a location storage service;
wherein to store the location of the aerosol provision device, the device is configured to send the location of the aerosol provision device to the location storage service; and
to provide the indication of the last-known location of the aerosol provision device, the device is configured to retrieve, from the location storage service, the last-known location of the aerosol provision device.

88. The system according to any of clauses 79-87, wherein:
the aerosol provision device is configured to communicate the location of the aerosol provision device to the user device via a Bluetooth™ protocol.

89. The system according to any of clauses 79-87, wherein:
the aerosol provision device is configured to communicate the location of the aerosol provision device to the user device via a mobile network.

90. The system according to any of clauses 79-89, wherein:
the device is configured to provide the indication of the last-known location of the aerosol provision device based on the received location when the device and the aerosol provision device are not in remote communication.

1. A method of tracking the location of an aerosol provision device by a user device, the method comprising:
when the user device and the aerosol provision device are in remote communication:
receiving, by the user device from the aerosol provision device, a location of the aerosol provision device;
storing, by the user device, the location of the aerosol provision device; and
in response to a request for the location of the aerosol provision device at the user device, providing, by the user device, an indication of the last-known location of the aerosol provision device based on the stored location.

2. The method according to claim 1, wherein:
the location of the aerosol provision device received by the user device is a location determined using a global navigation satellite system (GNSS).

3. The method according to claim 2, wherein:
the GNSS is selected from the group comprising: Global Positioning System (GPS); Global Navigation Satellite System (GLONASS); Galileo; and BeiDou Navigation Satellite System (BDS).

4. The method according to claim 1, wherein:
the location of the aerosol provision device received by the user device is a location determined using Wi-Fi™ positioning, wherein the location of the aerosol provision device is determined based on the characteristics of nearby wireless access points.

5. The method according to claim 1, wherein:
the location of the aerosol provision device received by the user device is a location determined using cell phone tower triangulation.

6. The method according to claim 1, wherein:
the location of the aerosol provision device received by the user device is a location determined using communication over a Low Power Wide Area Network (LPWAN).

7. The method according to claim 1, wherein:
the location of the aerosol provision device received by the user device is a location determined using communication over a low power internet of things (IoT) network.

8. The method according to claim 1, wherein:
the location of the aerosol provision device received by the user device is a location determined based on recognising a Near-field communication tag having a known location.

9. The method according to claim 1, wherein:
storing the location of the aerosol provision device by the user device comprises sending the location of the aerosol provision device to a location storage service; and
providing the indication of the last-known location of the aerosol provision device by the user device comprises retrieving, from the location storage service, the last-known location of the aerosol provision device.

10. The method according to claim 1, wherein:
receiving the location of the aerosol provision device from the aerosol provision device is via a Bluetooth™ protocol.

11. The method according to claim 1, wherein:
the location of the aerosol provision device is received from the aerosol provision device via a mobile network.

12. The method according to claim 1, wherein:
providing, by the user device, an indication of the last-known location of the aerosol provision device based on the stored location is performed when the user device and the aerosol provision device are not in remote communication.

13. A device for tracking the location of an aerosol provision device, the device configured to:
when the device and the aerosol provision device are in remote communication:
receive, by the device from the aerosol provision device, a location of the aerosol provision device;
store, by the device, the location of the aerosol provision device; and
in response to a request for the location of the aerosol provision device at the device, provide an indication of the last-known location of the aerosol provision device based on the stored location.

14. The device according to claim 13, wherein:
the location of the aerosol provision device received by the device is a location determined using a global navigation satellite system (GNSS).

15. (canceled)

16. (canceled)

17. The device according to claim 13, wherein:
the location of the aerosol provision device received by the device is a location determined using cell phone tower triangulation.

18. The device according to claim 13, wherein:
the location of the aerosol provision device received by the device is a location determined using communication over a Low Power Wide Area Network (LPWAN).

19. The device according to claim 13, wherein:
the location of the aerosol provision device received by the device is a location determined using communication over a low power internet of things (IOT) network.

20. The device according to claim 13, wherein:
the location of the aerosol provision device received by the device is a location determined based on recognising a Near-field communication tag having a known location.

21. The device according to claim 13, wherein:
to store the location of the aerosol provision device, the device is configured to send the location of the aerosol provision device to a location storage service; and
to provide the indication of the last-known location of the aerosol provision device, the device is configured to retrieve, from the location storage service, the last-known location of the aerosol provision device.

22-24. (canceled)

25. A computer-readable medium comprising instructions which, when executed by processing circuitry of a device, cause the device to become configured to:
when the device and the aerosol provision device are in remote communication:
receive, by the device from the aerosol provision device, a location of the aerosol provision device;
store, by the device, the location of the aerosol provision device; and
in response to a request for the location of the aerosol provision device at the device, provide an indication of the last-known location of the aerosol provision device based on the stored location.
